(19) United States
(12) Patent Application Publication
(10) Pub. No.: US 2024/0422651 A1
(43) Pub. Date: Dec. 19, 2024

(54) SYSTEMS AND METHODS FOR BARRING DISASTER ROAMING BY USER EQUIPMENTS IN CELLS RESERVED FOR OPERATOR USE

(71) Applicant: Telefonaktiebolaget LM Ericsson (PUBL), Stockholm (SE)

(72) Inventor: Mattias Bergström, SOLLENTUNA (SE)

(21) Appl. No.: 18/708,281

(22) PCT Filed: Nov. 11, 2022
(86) PCT No.: PCT/IB2022/060877

§ 371 Date: May 8, 2024

Related U.S. Application Data
(60) Provisional application No. 63/278,742, filed on Nov. 12, 2021.

(51) Int. Cl. H04W 48/06; H04W 4/90

(52) U.S. Cl. CPC H04W 48/06; H04W 4/90

(57) ABSTRACT

A method (700) by a user equipment for preventing disaster roaming in a first cell reserved for operator use includes obtaining (702) information indicating that the first cell associated with a first network is reserved for operator use. Based on the information indicating that the first cell is reserved for operator use and based on the UE being assigned an access identity that is associated with disaster roaming, the user equipment determines (704) to treat the first cell as barred.

### TECHNICAL FIELD

The present disclosure relates, in general, to wireless communications and, more particularly, systems and methods for barring disaster roaming by User Equipments (UEs) in cells reserved for operator use.

### BACKGROUND

In New Radio (NR), there is a concept of Access Identities, which is an identity that a user equipment (UE) may take on or otherwise be assigned or associated with. Different identities are for different purposes. For example, Access Identity 2 is for UEs configured with mission critical services, and Access Identity 1 is for UEs configured with multimedia priority service. Access Identity 0 is for UEs that are not configured with any other access identity. The UE considers the Access Identity, for example, when the UE is determining whether or not to access a cell based on the UAC framework (described below).

### Unified Access Control (UAC)

UAC is a feature that allows the network to control if and when UEs are allowed to access a cell. It is mainly used for overload situations and allows the operator to configure, for example, Public Land Mobile Network (PLMN) or network-specific access barring parameters. These access barring parameters may include, for example, probability indicators that a UE should be allowed to access and duration parameters indicating how long a UE may be prevented from attempt of access.

UAC considers two aspects: an Access Identity of the UE and an Access Category of the UE.

As described above, a UE can be assigned to a certain Access Identity, which may correspond roughly to the type of the UE. The UAC framework then allows the network to control, per Access Identity, whether UEs should be allowed to access the cell.

The UAC framework also provides the ability for the network to control whether access is allowed by a UE based on the reason why the UE wants to connect to the network. This is achieved using Access Categories. For example, if the UE wants to connect to the network to use emergency services, the UE might be allowed to do so. However, a UE that wants to access the network to use normal internet traffic may not be allowed to access the cell. As another example, in overload situations, a UE that wants to access the network for normal internet usage may have a much smaller likelihood of being allowed to attempt access if the network sets the probability indicators appropriately).

The network broadcasts in system information (SI) the parameters associated with UAC.

### Minimization of Service Interruption (MINT)

According to the MINT feature, a first network can let UEs of a second network roam in the first network in case of a disaster situation in the second network. Such roaming is referred to as “disaster roaming”. Disaster roaming is achieved by the first network when the first network provides an indication in the SI that indicates that UEs of the second network can perform disaster roaming. The indication may either be a PLMN identity of the second network or it may be an indication which indicates that UEs of any network can perform disaster roaming.

When a UE performs disaster roaming, the UE will consider itself configured with a particular Access Identity, namely Access Identity 3. One motivation for associating an Access Identity with disaster roaming UEs is that it may be preferred by an operator (e.g., the operator of the first network) to block disaster roaming UEs from accessing the network by means of the UAC framework. It has been agreed in 3GPP that such blocking (also referred to as “barring” according to 3GPP terminology) can be achieved by the network providing special barring-parameters that are applied by UEs that are disaster roaming, i.e. UEs which are configured with Access Identity 3.

The network can, therefore, bar disaster roaming UEs more aggressively compared to non-disaster roaming UEs by setting the barring parameters more aggressively for disaster roaming UEs.

### Reserved for Operator Use

In certain situations, an operator may want to dedicate one or more cells in its network to UEs that belong to the operator. This may be beneficial when some trial or testing of the cells is or should be performed. Specifically, the operator may have special UEs that can be used for testing purposes that may be able to log different events. The operator may, in such situations, want the other UEs (e.g., UEs not belonging to the operator) to avoid accessing the cells.

There exists a flag in SI for this purpose. It is called “cellReservedForOperatorUse”. This flag can be set to the value “reserved” or the value “notReserved”. If set to reserved, only UEs belonging to the operator are supposed to select the cell. By contrast, f set to notReserved, other UEs can select the cell. For these purposes, UEs that belong to the operator will be configured differently than other UEs. For example, the UEs belonging to the operator will be configured with Access Identity 11 or 15, and other UEs will not be assigned these Access Identities.

Below is an excerpt from 3GPP TS 38.304 version 16.6.0:
When cell status is indicated as “not barred” and “reserved” for operator use for any PLMN/SNPN and not “true” for other use and not “true” for future use,
   UEs assigned to Access Identity 11 or 15 operating in their HPLMN/EHPLMN shall treat this cell as candidate during the cell selection and reselection procedures if the field cellReservedForOperatorUse for that PLMN set to “reserved”.
   UEs assigned to Access Identity 11 or 15 shall treat this cell as candidate during the cell selection and reselection procedures if the field cellReservedForOperatorUse for selected/registered SNPN is set to “reserved”.
   UEs assigned to an Access Identity 0, 1, 2 and 12 to 14 shall behave as if the cell status is “barred” in case the cell is “reserved for operator use” for the registered PLMN/SNPN or the selected PLMN/SNPN.
NOTE 1: Access Identities 11, 15 are only valid for use in the HPLMN/EHPLMN; Access Identities 12, 13, 14 are only valid for use in the home country as specified in TS 22.261 [12].
   The excerpt shows how UEs with Access Identity 11 or 15 (i.e., UEs belonging to the operator) consider a cell as candidate for cell selection and reselection if the field cellReservedForOperatorUse is set to reserved. By contrast UEs assigned to Access Identity 0, 1, 2, and 12 to 14 consider the cell as barred in case the cell is reserved for operator use.

There currently exist certain challenge(s), however. For example, as discussed above, a UE that is performing disaster roaming will be associated with Access Identity 3. Per 3GPP TS 38.304, such a UE will not consider the cell as barred even if the cell is reserved for operator use. This means the UE may select the cell even though it is reserved for operator use. As a result, the disaster roaming UE may cause errors in cells reserved for operator use. Such UEs may also obscure logging or consume resources even though the UEs are not supposed to be in the cell.

### SUMMARY

Certain aspects of the disclosure and their embodiments may provide solutions to these or other challenges. For example, according to certain embodiments, methods and systems are provided that result in a UE that is associated with Access Identity 3 considering itself barred in a cell if the cell is indicated to be reserved for operator use.

According to certain embodiments, a method by a UE for preventing disaster roaming in a first cell reserved for operator use includes obtaining information indicating that the first cell associated with a first network is reserved for operator use. Based on the information indicating that the first cell is reserved for operator use and based on the UE being assigned an access identity that is associated with disaster roaming, the UE determines to treat the first cell as barred.

According to certain embodiments, a UE for preventing disaster roaming in a first cell reserved for operator use is configured to obtain information indicating that the first cell associated with a first network is reserved for operator use. Based on the information indicating that the first cell is reserved for operator use and based on the UE being assigned an access identity that is associated with disaster roaming, the UE is configured to determine to treat the first cell as barred.

According to certain embodiments, a method by a network node for preventing disaster roaming by a UE in a first cell reserved for operator use includes transmitting, to the UE, at least one of information indicating that the first cell associated with a first network is reserved for operator use, and information indicating that the UE is assigned an access identity that is associated with disaster roaming.

According to certain embodiments, a network node for preventing disaster roaming by a UE in a cell reserved for operator use is configured to transmit, to the UE, at least one of information indicating that the first cell associated with a first network is reserved for operator use, and information indicating that the UE is assigned an access identity that is associated with disaster roaming.

Certain embodiments may provide one or more of the following technical advantage(s). For example, certain embodiments may provide a technical advantage of avoiding errors by ensuring that disaster roaming UEs will not connect to a cell that is reserved for operator use. As further examples, certain embodiments may avoid the obscuring of logging results and resource waste in a network.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example communication system, according to certain embodiments;

FIG. 2 illustrates an example UE, according to certain embodiments;

FIG. 3 illustrates an example network node, according to certain embodiments;

FIG. 4 illustrates a block diagram of a host, according to certain embodiments;

FIG. 5 illustrates a virtualization environment in which functions implemented by some embodiments may be virtualized, according to certain embodiments;

FIG. 6 illustrates a host communicating via a network node with a UE over a partially wireless connection, according to certain embodiments;

FIG. 7 illustrates a method by a UE for preventing disaster roaming in a first cell reserved for operator use, according to certain embodiments; and

FIG. 8 illustrates a method by a network node for preventing disaster roaming by a UE in a first cell reserved for operator use, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

According to certain embodiments, a UE determines that it should attempt to perform disaster roaming. This may for example be determined at least partially based on the UE not identifying any cell of the home PLMN of the UE.

In a particular embodiment, the UE determines that is configured with a configuration applicable for disaster roaming. This may mean that the UE is assigned or otherwise associated with a special Access Identity that is associated with disaster roaming. For example, in a particular embodiment, the UE may be assigned to Access Identity 3.

In certain embodiments, the UE then identifies a cell of a network that indicates that disaster roaming is applicable. Based on information provided from the cell, the UE then determines whether the UE is eligible to perform disaster roaming in this cell. For example, according to a particular embodiment, this may be determined based on a PLMN-indication provided from the network. Specifically, the UE may consider itself eligible for disaster roaming if the PLMN that the UE is associated with (e.g. being the UE's home PLMN) matches the information provided from the cell. As another example, in a particular embodiment, the UE may determine that is eligible to perform disaster roaming in the cell based on an indication that indicates that UEs of any PLMN are eligible for disaster roaming.

According to certain embodiments, the UE then determines whether the cell indicates that the cell is reserved for operator use. If the UE determines that the cell is reserved for operator use, the UE will consider the cell as barred. Thereafter, the UE will refrain from (re)selecting the cell or accessing the cell if the cell is considered barred.

On the other hand, if the cell does not indicate that the cell is reserved for operator use, the UE will consider the cell as not barred. Thus, the UE will consider the cell a candidate for (re)selecting or accessing.

It may be noted that current NR specifications provide several ways in which a UE may consider a cell as barred. If the mechanism described above results in the UE considering a cell as not barred, the cell may still be considered barred for other reasons.

One example implementation of certain embodiments described herein is indicated in the text below, which is an excerpt from 3GPP TS 38.304 version 16.6.0. The italicized and underlined text shows the additional language that implements certain embodiments described herein:
When cell status is indicated as “not barred” and “reserved” for operator use for any PLMN/SNPN and not “true” for other use and not “true” for future use,
   UEs assigned to Access Identity 11 or 15 operating in their HPLMN/EHPLMN shall treat this cell as candidate during the cell selection and reselection procedures if the field cellReservedForOperatorUse for that PLMN set to “reserved”.
   UEs assigned to Access Identity 11 or 15 shall treat this cell as candidate during the cell selection and reselection procedures if the field cellReservedForOperatorUse for selected/registered SNPN is set to “reserved”.
   UEs assigned to an Access Identity 0, 1, 2 and 12 to 14 shall behave as if the cell status is “barred” in case the cell is “reserved for operator use” for the registered PLMN/SNPN or the selected PLMN/SNPN.
   UEs assigned to Access Identity 3 shall behave as if the cell status is “barred” in case the cell is “reserved for operator use” for the registered PLMN/SNPN or the selected PLMN/SNPN.
NOTE 1: Access Identities 11, 15 are only valid for use in the HPLMN/EHPLMN; Access Identities 12, 13, 14 are only valid for use in the home country as specified in TS 22.261 [12].
   Thus, in a particular embodiment, a UE that is assigned an Access Identity 3 will behave as if the cell status is barred in case the cell is reserved for operator use for the registered PLMN/SNPN or the selected PLMN/SNPN.

Another example implementation of certain embodiments may be implemented by modifying the excerpt from 3GPP TS 38.304 version 16.6.0 as follows (where the modified text is shown as being italicized and underlined):
When cell status is indicated as “not barred” and “reserved” for operator use for any PLMN/SNPN and not “true” for other use and not “true” for future use,
   UEs assigned to Access Identity 11 or 15 operating in their HPLMN/EHPLMN shall treat this cell as candidate during the cell selection and reselection procedures if the field cellReservedForOperatorUse for that PLMN set to “reserved”.
   UEs assigned to Access Identity 11 or 15 shall treat this cell as candidate during the cell selection and reselection procedures if the field cellReservedForOperatorUse for selected/registered SNPN is set to “reserved”.
   UEs assigned to an Access Identity 0, 1, 2, 3 and 12 to 14 shall behave as if the cell status is “barred” in case the cell is “reserved for operator use” for the registered PLMN/SNPN or the selected PLMN/SNPN.
NOTE 1: Access Identities 11, 15 are only valid for use in the HPLMN/EHPLMN; Access Identities 12, 13, 14 are only valid for use in the home country as specified in TS 22.261 [12].
   Thus, in a particular embodiment, a UE that is assigned an Access Identity 3 will behave as if the cell status is barred in case the cell is reserved for operator use for the registered PLMN/SNPN or the selected PLMN/SNPN.

Yet another example implementation of certain embodiments may be implemented by modifying the excerpt from 3GPP TS 38.304 version 16.6.0 as follows (where the modified text is shown as being italicized and underlined):
When cell status is indicated as “not barred” and “reserved” for operator use for any PLMN/SNPN and not “true” for other use and not “true” for future use,
   UEs assigned to Access Identity 11 or 15 operating in their HPLMN/EHPLMN shall treat this cell as candidate during the cell selection and reselection procedures if the field cellReservedForOperatorUse for that PLMN set to “reserved”.
   UEs assigned to Access Identity 11 or 15 shall treat this cell as candidate during the cell selection and reselection procedures if the field cellReservedForOperatorUse for selected/registered SNPN is set to “reserved”.
   UEs assigned to an Access Identity 0, 1, 2 and 12 to 14 shall behave as if the cell status is “barred” in case the cell is “reserved for operator use” for the registered PLMN/SNPN or the selected PLMN/SNPN.
   UEs assigned to Access Identity 3 shall behave as if the cell status is “barred” in case the cell is “reserved for operator use” for the PLMN in which the UE is performing disaster roaming.
NOTE 1: Access Identities 11, 15 are only valid for use in the HPLMN/EHPLMN; Access Identities 12, 13, 14 are only valid for use in the home country as specified in TS 22.261 [12].
   Thus, in a particular embodiment, a UE that is assigned an Access Identity 3 will behave as if the cell status is barred in case the cell is reserved for operator use for PLMN in which the UE is performing disaster roaming.

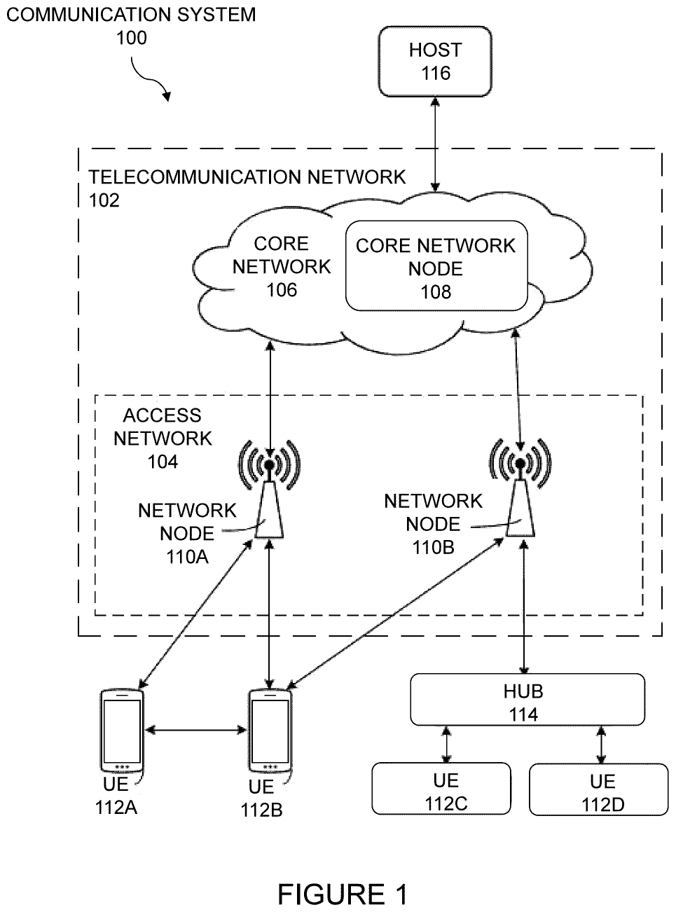

FIG. 1 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 1 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

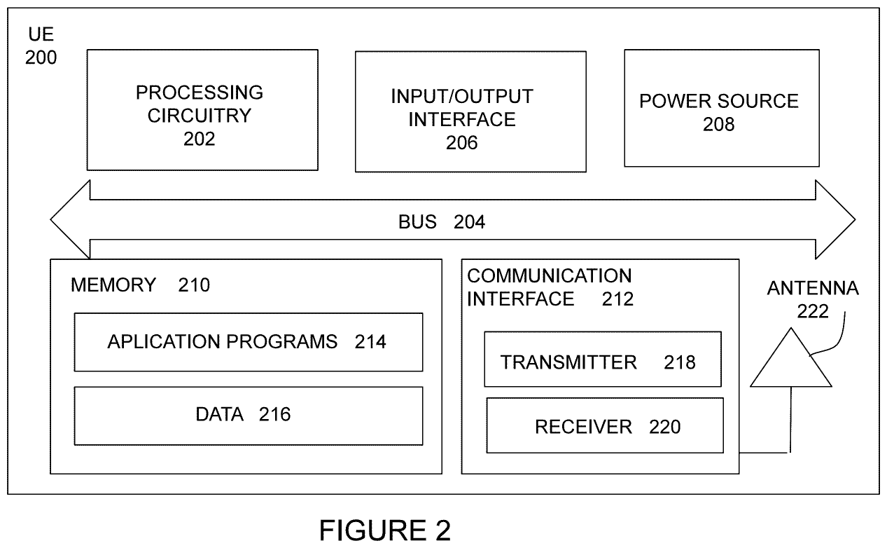

FIG. 2 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 2. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 2.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

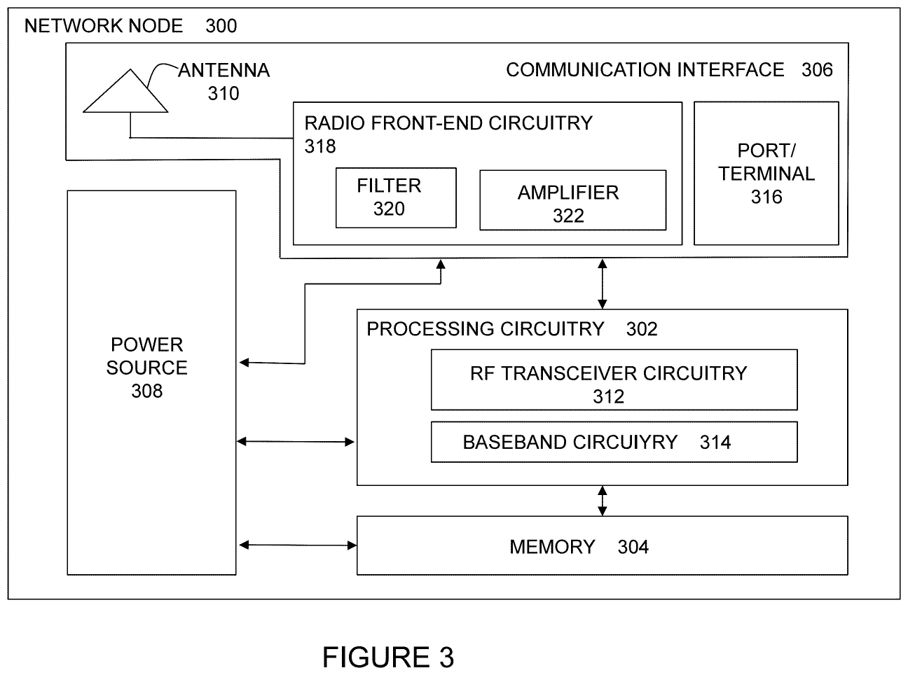

FIG. 3 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 3 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

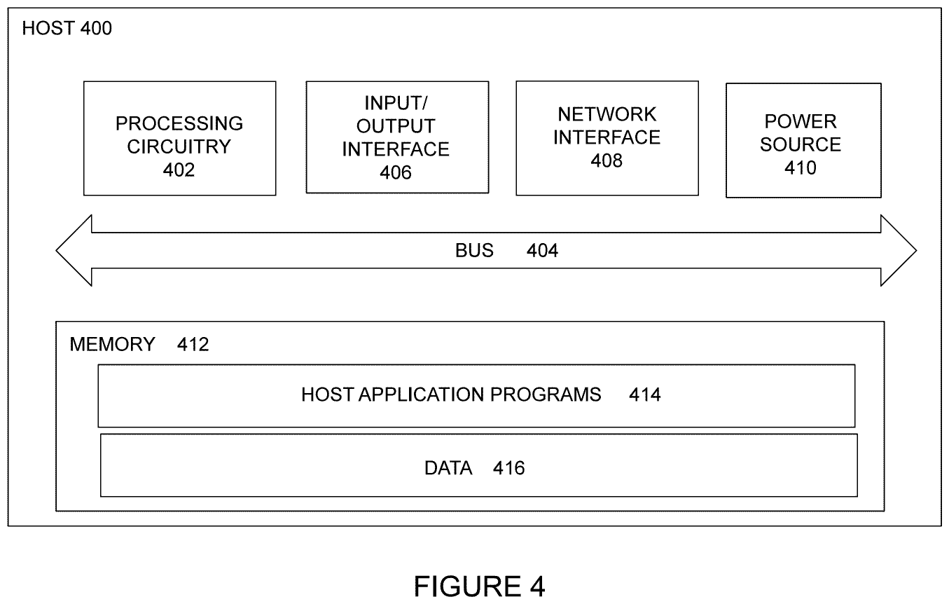

FIG. 4 is a block diagram of a host 400, which may be an embodiment of the host 116 of FIG. 1, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

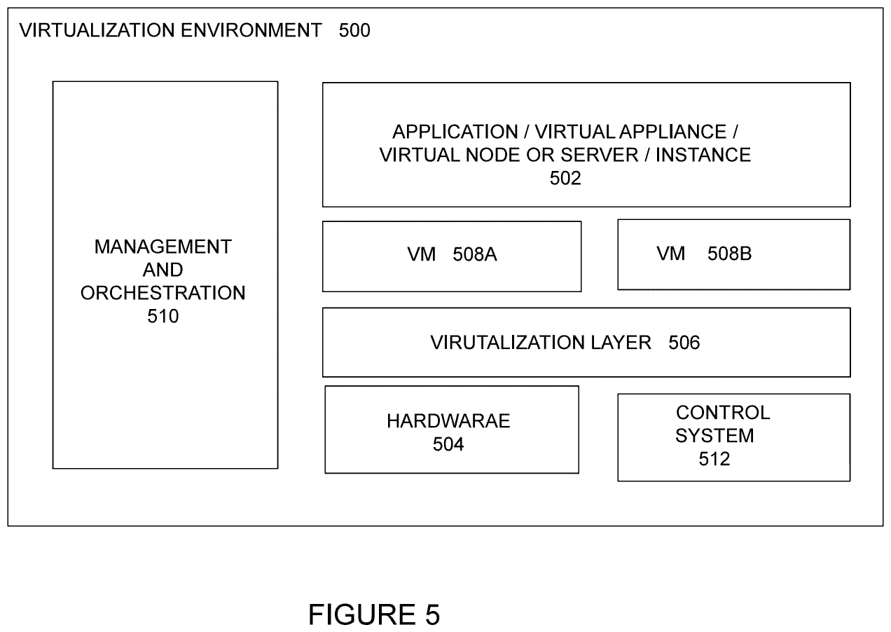

FIG. 5 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

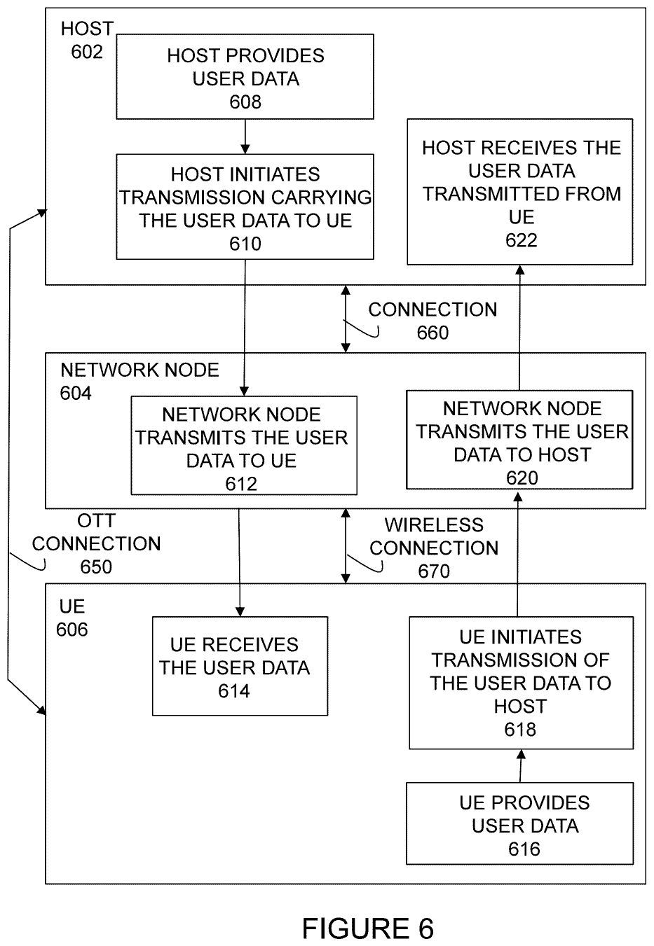

FIG. 6 shows a communication diagram of a host 602 communicating via a network node 604 with a UE 606 over a partially wireless connection in accordance with some embodiments.

Example implementations, in accordance with various embodiments, of the UE (such as a UE 112a of FIG. 1 and/or UE 200 of FIG. 2), network node (such as network node 110a of FIG. 1 and/or network node 300 of FIG. 3), and host (such as host 116 of FIG. 1 and/or host 400 of FIG. 4) discussed in the preceding paragraphs will now be described with reference to FIG. 6.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 1) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

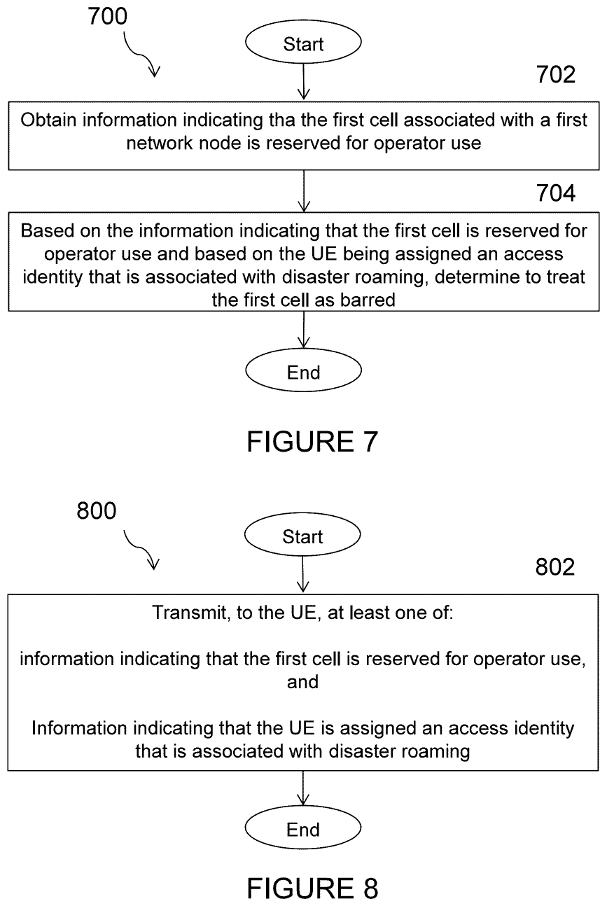

FIG. 7 illustrates a method 700 by a UE 112 for preventing disaster roaming in a first cell reserved for operator use, according to certain embodiments. The method begins at step 702 when the UE 112 obtains information indicating that the first cell associated with a first network is reserved for operator use. Based on the information indicating that the first cell is reserved for operator use and based on the UE being assigned an access identity that is associated with disaster roaming, the UE 112 determines to treat the first cell as barred, at step 704.

In a particular embodiment, the UE 112 determines that the UE 112 is assigned the access identity that is associated with disaster roaming.

In a particular embodiment, the access identity indicates that the UE 112 is assigned to an Access Identity 3.

In a particular embodiment, prior to determining that the UE 112 is assigned the access identity that is associated with disaster roaming, the UE 112 identifies that the UE 112 cannot access a second cell associated with a second network and determines that the UE 112 is configured for disaster roaming.

In a further particular embodiment, the UE 112 was previously served in a second cell of the second network and/or the second network comprises a home network.

In a particular embodiment, when determining to treat the first cell as barred, the UE 112 determines not to take at least one action. Determining not to take the at least one action includes at least one of determining not to camp on the first cell; determining not to access the first cell; determining not to select the first cell; and determining not to reselect the first cell.

In a particular embodiment, when determining to treat the first cell as barred, the UE 112 performs at least one of: camping on a second cell; accessing the second cell; selecting the second cell; and reselecting the second cell.

In a particular embodiment, the first network and/or the second network comprises a PLMN.

In a particular embodiment, when obtaining the information indicating that the first cell reserved for operator use, the UE 112 receives the information from a network node 110 associated with the first cell.

FIG. 8 illustrates a method 800 by a network node 110 for preventing disaster roaming by a UE 110 in a first cell reserved for operator use, according to certain embodiments. At step 802, the network node 110 transmitting, to the UE, at least one of: information indicating that the first cell associated with a first network is reserved for operator use, and information indicating that the UE is assigned an access identity that is associated with disaster roaming.

In a particular embodiment, the access identity indicates that the UE is assigned to an Access Identity 3.

In a particular embodiment, the UE is or was previously served in a second cell associated with a second network.

In a particular embodiment, the second network comprises a home network.

In a particular embodiment, the first network and/or the second network comprises a Public Land Mobile Network, PLMN.

In a particular embodiment, the information triggers the UE to treat the first cell as barred.

In a particular embodiment, treating the first cell as barred includes at least one of: not camping on the first cell; not accessing the first cell; not selecting the first cell; and not reselecting the first cell.

In a particular embodiment, the network node comprises a gNB.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group a Example Embodiments

Example Embodiment A1. A method by a user equipment for preventing disaster roaming in a cell reserved for operator use, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for preventing disaster roaming in a cell reserved for operator use, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for preventing disaster roaming in a first cell reserved for operator use, the method comprising: obtaining information indicating whether the first cell associated with a first network is reserved for operator use; and determining whether to access the first cell based on the information indicating that the first cell is reserved for operator use.

Example Embodiment C2. The method of Example Embodiment C1, wherein, the UE is or was previously served in a second cell associated with a second network.

Example Embodiment C3. The method of Example Embodiment C2, wherein the second network comprises a home network.

Example Embodiment C4. The method of any one of Example Embodiments C1 to C3, wherein the first network and/or the second network comprises a PLMN.

Example Embodiment C5. The method of any one of Example Embodiments C1 to C4, wherein the information indicates that the first cell is reserved for operator use, and wherein determining whether to access the first cell comprises determining not to access the first cell based on the information indicating that the first cell is reserved for operator use.

Example Embodiment C6. The method of Example Embodiment C5, wherein determining not to access the first cell comprises at least one of: determining that the UE is barred from accessing the first cell; determining not to select or reselect the first cell; and/or determining not to access the first cell.

Example Embodiment C7. The method of any one of Example Embodiments C1 to C4, wherein the information indicates that the first cell is not reserved for operator use, and wherein determining whether to access the first cell comprises determining to access the first cell based on the information indicating that the first cell is reserved for operator use.

Example Embodiment C8. The method of Example Embodiment C7, wherein determining to access the first cell comprises at least one of: determining that the UE is not barred from accessing the first cell; determining to select or reselect the first cell; and/or determining to access the first cell.

Example Embodiment C9. The method of any one of Example Embodiments C1 to C8, wherein obtaining the information comprises receiving the information from a network node associated with the first cell.

Example Embodiment C10. The method of any one of Example Embodiments C1 to C9, wherein prior to determining whether to access the first cell, the UE performs at least one of identifying that the UE cannot access the second cell associated with the second network; identifying that the UE cannot access any cell associated with the second network; determining that the UE is configured with a configuration enabling disaster roaming; determining that the UE is configured to perform disaster roaming based on a special access identity associated with the UE; determining that the UE should attempt to perform disaster roaming in the first cell; determining that the UE is eligible to perform disaster roaming in the first cell; determining that the UE is eligible to perform disaster roaming in the first cell based on information received from the first cell; and/or determining that the UE is eligible to perform disaster roaming in the first cell based on or in response to matching information received from the first cell with an identifier of the second network with which the UE is associated.

Example Embodiment C11. The method of any one of Example Embodiments C1 to C10, wherein the UE is associated with an access identity value of Access Identity 3, and wherein the UE determines not to access the first cell based on the UE being associated with the access identity value of Access Identity 3.

Example Embodiment C12. The method of Example Embodiment C11, wherein the information indicates that the UE is associated with the access identity value of Access Identity 3.

Example Embodiment C13. The method of Example Embodiments C1 to C12, further comprising: providing user data; and forwarding the user data to a host via the transmission to the network node.

Example Embodiment C14. A user equipment comprising processing circuitry configured to perform any of the methods of Example Embodiments C1 to C13.

Example Embodiment C15. A wireless device comprising processing circuitry configured to perform any of the methods of Example Embodiments C1 to C13.

Example Embodiment C16. A computer program comprising instructions which when executed on a computer perform any of the methods of Example Embodiments C1 to C13.

Example Embodiment C17. A computer program product comprising computer program, the computer program comprising instructions which when executed on a computer perform any of the methods of Example Embodiments C1 to C13.

Example Embodiment C18. A non-transitory computer readable medium storing instructions which when executed by a computer perform any of the methods of Example Embodiments C1 to C13.

### Group D Example Embodiments

Example Embodiment D1. A method by a network node for preventing disaster roaming by a User Equipment (UE) in a cell reserved for operator use, the method comprising: transmitting, to the UE, information indicating whether the first cell associated with a first network is reserved for operator use Example Embodiment D2. The method of Example Embodiment D1, wherein, the UE is or was previously served in a second cell associated with a second network.

Example Embodiment D3. The method of Example Embodiment D2, wherein the second network comprises a home network.

Example Embodiment D4. The method of any one of Example Embodiments D1 to D3, wherein the first network and/or the second network comprises a PLMN.

Example Embodiment D5. The method of any one of Example Embodiments D1 to D4, wherein the information indicates that the first cell is reserved for operator use, and wherein the UE is configured to determine not to access the first cell based on the information indicating that the first cell is reserved for operator use.

Example Embodiment D6. The method of Example Embodiment D5, wherein when determining not to access the first cell, the UE is configured to perform at least one of: determining that the UE is barred from accessing the first cell; determining not to select or reselect the first cell; and/or determining not to access the first cell.

Example Embodiment D7. The method of any one of Example Embodiments D1 to D4, wherein the information indicates that the first cell is not reserved for operator use, and wherein the UE is configured to determine to access the first cell based on the information indicating that the first cell is reserved for operator use.

Example Embodiment D8. The method of Example Embodiment D7, wherein when determining to access the first cell the UE is configured to perform at least one of determining that the UE is not barred from accessing the first cell; determining to select or reselect the first cell; and/or determining to access the first cell.

Example Embodiment D9. The method of any one of Example Embodiments D1 to D9, wherein prior to determining whether to access the first cell, the UE is configured to perform at least one of identifying that the UE cannot access the second cell associated with the second network; identifying that the UE cannot access any cell associated with the second network; determining that the UE is configured with a configuration enabling disaster roaming; determining that the UE is configured to perform disaster roaming based on a special access identity associated with the UE; determining that the UE should attempt to perform disaster roaming in the first cell; determining that the UE is eligible to perform disaster roaming in the first cell; determining that the UE is eligible to perform disaster roaming in the first cell based on information received from the first cell; and/or determining that the UE is eligible to perform disaster roaming in the first cell based on or in response to matching information received from the first cell with an identifier of the second network with which the UE is associated.

Example Embodiment D10. The method of any one of Example Embodiments D1 to D9, wherein the UE is associated with an access identity value of Access Identity 3, and wherein the UE is configured to determine not to access the first cell based on the UE being associated with the access identity value of Access Identity 3.

Example Embodiment D11. The method of Example Embodiment D10, wherein the information indicates that the UE is associated with the access identity value of Access Identity 3.

Example Embodiment D12. The method of any one of Example Embodiments D1 to D11, wherein the UE is configured to determining whether to access the first cell based on the information indicating that the first cell is reserved for operator use.

Example Embodiment D13. The method of any one of Example Embodiments D1 to D12, wherein the network node comprises a gNodeB (gNB).

Example Embodiment D14. The method of any of the previous Example Embodiments, further comprising: obtaining user data; and forwarding the user data to a host or a user equipment.

Example Embodiment D15. A network node comprising processing circuitry configured to perform any of the methods of Example Embodiments D1 to D14.

Example Embodiment D16. A computer program comprising instructions which when executed on a computer perform any of the methods of Example Embodiments D1 to D14.

Example Embodiment D17. A computer program product comprising computer program, the computer program comprising instructions which when executed on a computer perform any of the methods of Example Embodiments D1 to D14.

Example Embodiment D18. A non-transitory computer readable medium storing instructions which when executed by a computer perform any of the methods of Example Embodiments D1 to D14.

### Group E Example Embodiments

Example Embodiment E1. A user equipment for preventing disaster roaming in a cell reserved for operator use, the user equipment comprising: processing circuitry configured to perform any of the steps of any of the Group A and C Example Embodiments; and power supply circuitry configured to supply power to the processing circuitry.

Example Embodiment E2. A network node for preventing disaster roaming in a cell reserved for operator use, the network node comprising: processing circuitry configured to perform any of the steps of any of the Group B and D Example Embodiments; power supply circuitry configured to supply power to the processing circuitry.

Example Embodiment E3. A user equipment (UE) for preventing disaster roaming in a cell reserved for operator use, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10.A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13.A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16.A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18.A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21.A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23.A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26.A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, for preventing disaster roaming in a first cell reserved for operator use, the method comprising:
obtaining information indicating that the first cell associated with a first network is reserved for operator use; and
based on the information indicating that the first cell is reserved for operator use and based on the UE being assigned an access identity that is associated with disaster roaming, determining to treat the first cell as barred.

2. The method of claim 1, comprising determining that the UE is assigned the access identity that is associated with disaster roaming.

3. The method of claim 1, wherein the access identity indicates that the UE is assigned to an Access Identity 3.

4. The method of claim 2, wherein prior to determining that the UE is assigned the access identity that is associated with disaster roaming, the method comprises:
identifying that the UE cannot access a second cell associated with a second network; and
determining that the UE is configured for disaster roaming.

5. The method of claim 4, wherein the UE was previously served in a second cell of the second network and/or the second network comprises a home network.

6.-9. (canceled)

10. A method by a network node for preventing disaster roaming by a User Equipment, UE, in a first cell reserved for operator use, the method comprising:
transmitting, to the UE, at least one of
information indicating that the first cell associated with a first network is reserved for operator use, and
information indicating that the UE is assigned an access identity that is associated with disaster roaming.

11.-17. (canceled)

18. A user equipment, UE, for preventing disaster roaming in a first cell reserved for operator use, the UE configured to:
obtain information indicating that the first cell associated with a first network is reserved for operator use; and
based on the information indicating that the first cell is reserved for operator use and based on the UE being assigned an access identity that is associated with disaster roaming, determine to treat the first cell as barred.

19. The UE of claim 18, configured to determine that the UE is assigned the access identity that is associated with disaster roaming.

20. The UE of claim 18, wherein the access identity indicates that the UE is assigned to an Access Identity 3.

21. The UE of claim 19, wherein prior to determining that the UE is assigned the access identity that is associated with disaster roaming, the UE is configured to:
identify that the UE cannot access a second cell associated with a second network; and
determine that the UE is configured for disaster roaming.

22. The UE of claim 21, wherein the UE was previously served in the second cell of the second network and/or the second network comprises a home network.

23. The UE of claim 18, wherein:
when determining to treat the first cell as barred, the UE is configured to determine not to take at least one action, and
when determining not to take the at least one action, the UE is configured to perform at least one of:
determining not to camp on the first cell;
determining not to access the first cell;
determining not to select the first cell; and
determining not to reselect the first cell.

24. The UE of claim 18, wherein when determining to treat the first cell as barred, the UE is configured to perform at least one of:
camping on a second cell;
accessing the second cell;
selecting the second cell; and
reselecting the second cell.

25. The UE of claim 18, wherein the first network and/or the second network comprises a Public Land Mobile Network, PLMN.

26. The UE of claim 18, wherein, when obtaining the information indicating that the first cell reserved for operator use, the UE is configured to receive the information from a network node associated with the first cell.

27. A network node for preventing disaster roaming by a User Equipment, UE, in a cell reserved for operator use, the network node configured to:
transmit, to the UE, at least one of information indicating that the first cell associated with a first network is reserved for operator use, and
information indicating that the UE is assigned an access identity that is associated with disaster roaming.

28. The network node of claim 27, wherein the access identity indicates that the UE is assigned to an Access Identity 3.

29. The network node of claim 27, wherein the UE is or was previously served in a second cell associated with a second network.

30. The network node of claim 29, wherein the second network comprises a home network.

31. The network node of claim 27, wherein the first network and/or the second network comprises a Public Land Mobile Network, PLMN.

32. The network node of claim 27, wherein the information triggers the UE to treat the first cell as barred.

33. The network node of claim 32, wherein treating the first cell as barred comprises at least one of:
not camping on the first cell;
not accessing the first cell;
not selecting the first cell; and
not reselecting the first cell.

34. The network node of claim 27, wherein the network node comprises a gNodeB, gNB.
